(19) United States
(12) Patent Application Publication
(10) Pub. No.: US 2020/0401139 A1
(43) Pub. Date: Dec. 24, 2020

(54) FLYING VEHICLE AND METHOD OF CONTROLLING FLYING VEHICLE

(71) Applicant: SONY CORPORATION, TOKYO (JP)

(72) Inventors: MIKIO NAKAI, KANAGAWA (JP); YUSUKE KUDO, KANAGAWA (JP); KUNIAKI TORII, KANAGAWA (JP)

(21) Appl. No.: 16/969,493

(22) PCT Filed: Dec. 12, 2018
(86) PCT No.: PCT/JP2018/045756

§ 371 Date: Aug. 12, 2020

(30) Foreign Application Priority Data
Feb. 20, 2018 (JP) 2018-027880

(51) Int. Cl. G05D 1/00; B64C 39/02; G05D 1/10; B64D 47/02; G06K 9/00; G06F 3/01

(52) U.S. Cl. CPC G05D 1/0094; B64C 39/024; G05D 1/101; B64C 2201/12; G06K 9/0063; G06F 3/017; B64C 2201/027; B64D 47/02

(57) ABSTRACT

[Object] To make it possible for a person on the ground to communicate with an arbitrary flying vehicle flying in the air. [Solution] According to the present disclosure, there is provided a flying vehicle including: an image presentation section that presents an image for requesting an action from a person; and a situation recognition section that recognizes a situation, in which the image presentation section presents the image on the basis of the situation recognized by the situation recognition section. This configuration makes it possible for the person on the ground to communicate with an arbitrary flying vehicle flying in the air.

### TECHNICAL FIELD

The present disclosure relates to a flying vehicle and a method of controlling the flying vehicle.

### BACKGROUND ART

For example, PTL 1 listed below has taught controlling an operation of an unmanned flying device on the basis of identification information indicated by an image captured by an imaging device mounted on the unmanned flying device.

### CITATION LIST

### Patent Literature

PTL 1: Japanese Unexamined Patent Application Publication No. 2017-140899

### SUMMARY OF THE INVENTION

### Problems to be Solved by the Invention

Some of the unmanned flying devices as described in the above-listed PTL 1, such as an existing drone, are operable by a communication apparatus (such as a remote controller) associated in advance. However, such a method is not applicable to an unmanned flying device that flies autonomously without an instruction from a person, because its communication partner is not fixed. This leads to a situation in which it is difficult for a person on the ground to know what communication means or application should be used to communicate with an arbitrary unmanned flying device that is flying around in the sky autonomously.

Moreover, there is voice recognition as a method typically used when an autonomous control part such as a robot communicates with a person. However, assuming the unmanned flying device flying in the sky, this method is difficult to be used, because of a deteriorated S/N ratio of voice information caused by attenuation of the voice due to a long distance, a noise from a thruster apparatus such as a propeller, and the like. Naturally, the person on the ground and the unmanned flying device are distant from each other, and thus a direct operation of the unmanned flying device using a touch panel or the like is not feasible.

The technology described in the above-listed PTL 1 proposes controlling the unmanned flying device by displaying an image for identifying a content of control from the ground. However, this method allows only unilateral information transfer from the person on the ground. Furthermore, the technology described in the above-listed PTL 1 only allows for control based on specific rules using a specific device, thus making it difficult for a person with little knowledge to have direct communication with drones flying around in the sky.

Therefore, it has been requested to enable a person on the ground to communicate with an arbitrary flying vehicle flying in the air.

### Means for Solving the Problems

According to the present disclosure, there is provided a flying vehicle including: an image presentation section that presents an image for requesting an action from a person; and a situation recognition section that recognizes a situation, in which the image presentation section presents the image on the basis of the situation recognized by the situation recognition section.

Moreover, according to the present disclosure, there is provided a method of controlling a flying vehicle, the method including: presenting an image for requesting an action from a person; and recognizing a situation, in which the image is presented on the basis of the recognized situation.

### Effects of the Invention

As described above, according to the present disclosure, it is possible for a person on the ground to communicate with an arbitrary flying vehicle flying in the air.

It is to be noted that the above-mentioned effects are not necessarily limitative; in addition to or in place of the above effects, there may be achieved any of the effects described in the present specification or other effects that may be grasped from the present specification.

### BRIEF DESCRIPTION OF DRAWING

FIG. 1 is a schematic diagram for describing an overview of the present disclosure.

FIG. 2 is a schematic diagram illustrating an example in which an unmanned flying device provides information for establishing communication between a smartphone or another communication apparatus operated by a person and the unmanned flying device.

FIG. 3 is a flowchart illustrating an outline of a process for performing communication between the unmanned flying device and the person.

FIG. 4 is a schematic diagram illustrating a hardware configuration of the unmanned flying device.

FIG. 5 is a schematic diagram illustrating a software configuration of the unmanned flying device.

FIG. 6 is a flowchart illustrating a flow of a process for projecting a circle figure and information on a ground surface.

FIG. 7 is a schematic diagram illustrating how the unmanned flying device moves.

### MODES FOR CARRYING OUT THE INVENTION

Hereinafter, description is given in detail of preferred embodiments of the present disclosure with reference to the accompanying drawings. It is to be noted that, in the present specification and drawings, repeated description is omitted for components substantially having the same functional configuration by assigning the same reference numerals.

It is to be noted that description is given in the following order.

### 1. Overview of Present Disclosure

### 2. Specific Configuration Example of Unmanned Flying Device

### 3. Specific Process Performed by Unmanned Flying Device

### 1. Overview of the Present Disclosure

The present embodiment allows for simple and prompt information transfer and communication between, for example, a person 20 on the ground and an unmanned flying device (flying vehicle) 1000 that flies autonomously without receiving an instruction from a specific navigator on the ground. For example, the unmanned flying device 1000 is assumed to fly in a fully autonomous manner, or assumed to be controlled by the cloud, etc., and a scene, etc. is assumed in which such an unmanned flying device 1000 is flying around in the sky. It is to be noted that the ground, as used herein, includes, besides a ground surface, a surface on an element such as a natural object and a building.

It is assumed that an instantaneous instruction may not be made from a remote controller (including a smartphone or the like) to the unmanned flying device 1000 flying in the fully autonomous manner or under control by the cloud. One reason for this is that the unmanned flying device 1000 and the remote controller are not paired because a person on the ground is not an owner of the unmanned flying device 1000 in the first place. Moreover, even when a company or the like owning the unmanned flying device 1000 prepares an application, etc. that is operable from the ground, it is difficult for the person on the ground to instantaneously install the application because attribution of the unmanned flying device 1000 flying closer is unclear.

Therefore, in the present embodiment, the unmanned flying device 1000 autonomously flying in the sky projects a projection image on a ground surface using a projector, laser, or the like, thereby allowing the unmanned flying device 1000 itself to provide information required for communication with the person 20. The person 20 on the ground takes an action on the basis of the projected image to thereby perform a reaction to the unmanned flying device 1000. Here, in a case where unilateral information transfer is performed from an unmanned flying device to a person, it is not possible to provide information from the person or to exchange information with the person. In the present embodiment, the unmanned flying device 1000 provides information required for communicating with the person 20, thereby allowing for bidirectional exchange of information between the person 20 and the unmanned flying device 1000. Furthermore, when projecting an image, projecting the image at a location and timing suitable for the person 20 to easily recognize it by sight on the basis of information on a position and line of sight of the person 20, topography, and the like, thereby optimally exchange bidirectional information between the person 20 and the unmanned flying device 1000. It is to be noted that, “image” as used herein includes a display item displayed on the ground surface by the projector, laser, etc., or a display item displayed on the ground surface by another method; the “image” includes all forms of the display item recognizable by a person or a device such as a camera.

As specific use cases, for example, examples described below are assumed.
To ask the unmanned flying device 1000 flying in front to deliver a package.
To purchase a commercial product from the unmanned flying device 1000 for mobile sales.
To receive a flyer or tissue paper for advertisement from the unmanned flying device 1000.
To request the unmanned flying device 1000 to film a commemorative video from the sky at a tourist attraction.
To ask the unmanned flying device 1000 to contact an ambulance service, a police department, a fire department, or the like at the time of emergency.

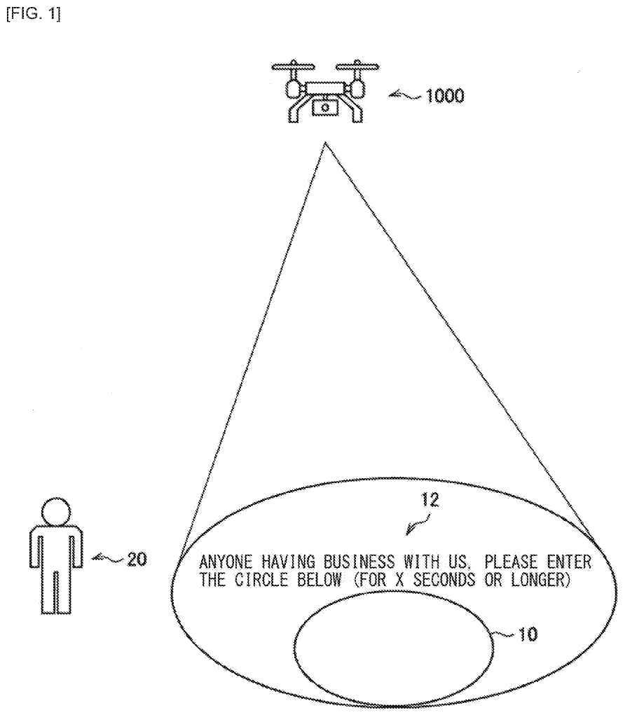

FIG. 1 is a schematic diagram for describing an overview of the present disclosure. In an example illustrated in FIG. 1, the unmanned flying device (moving vehicle) 1000 flying in the air projects a circle FIG. 10 toward the person 20 on the ground. In a case where the person 20 has some business with the unmanned flying device 1000, the unmanned flying device 1000 presents information 12 indicative of an instruction to enter the projected circle FIG. 10. In the example illustrated in FIG. 1, a projection image is projected indicative of the information “Anyone who have business with us, please enter the circle below (for X seconds or longer)”.

In response to the projection of this projection image, the unmanned flying device 1000 recognizes, from an image captured by a camera or the like, whether or not the person 20 has entered the circle FIG. 10. The information presented by the unmanned flying device 1000 may be appropriately changed depending on, for example, a flight area, a resting state, or the like of the unmanned flying device 1000. For example, in the information 12 illustrated in FIG. 1, a phrase “for X seconds or longer” may not be displayed.

Moreover, the present embodiment also assumes a pattern encouraging determination from a plurality of options by a combination with gestures of the person 20 such as “In a case of OO, please enter this circle and raise your right hand. In a case of ΔΔ, please raise your left hand”.

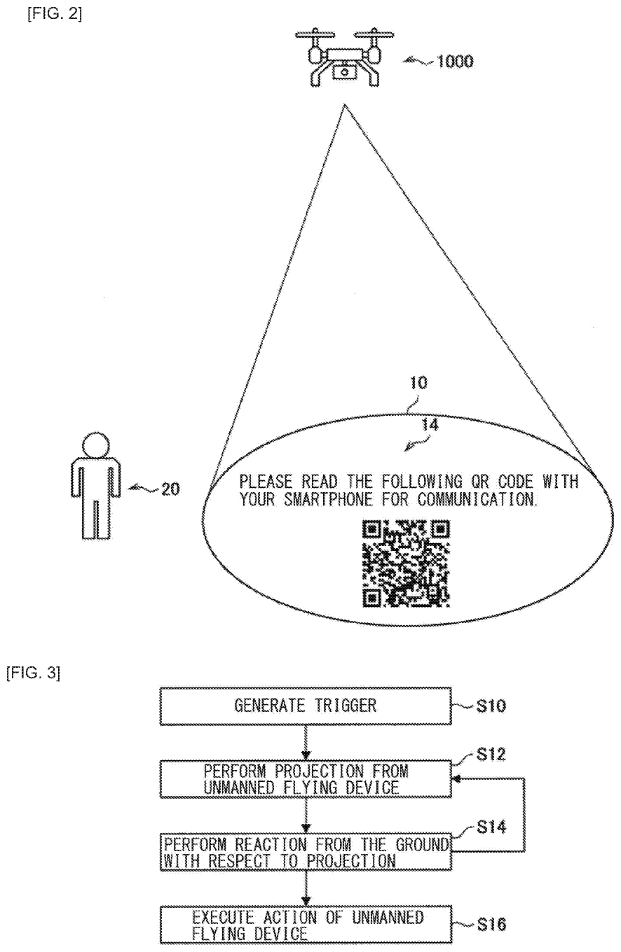

FIG. 2 is a schematic diagram illustrating an example in which the unmanned flying device 1000 projects a QR code (registered trademark) or another character string or image to thereby present information 14 for establishing communication between a smartphone or another communication apparatus operated by the person 20 and the unmanned flying device 1000. It is possible for the person 20 on the ground to establish communication with the unmanned flying device 1000 by reading the QR code (registered trademark) of the information 14 using his/her own communication apparatus. After the establishment of communication, an application or the like in the communication apparatus is used to communicate with the unmanned flying device 1000.

### 2. Specific Configuration Example of Unmanned Flying Device

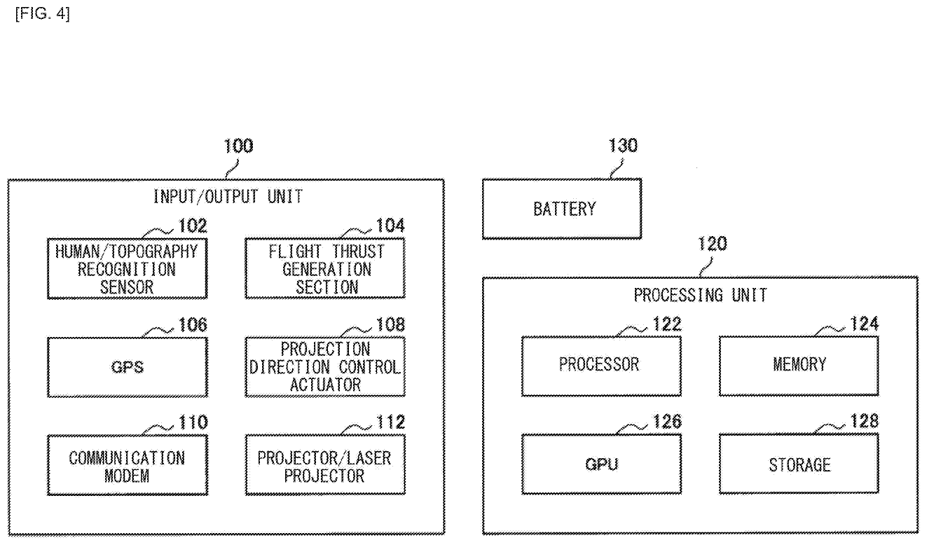

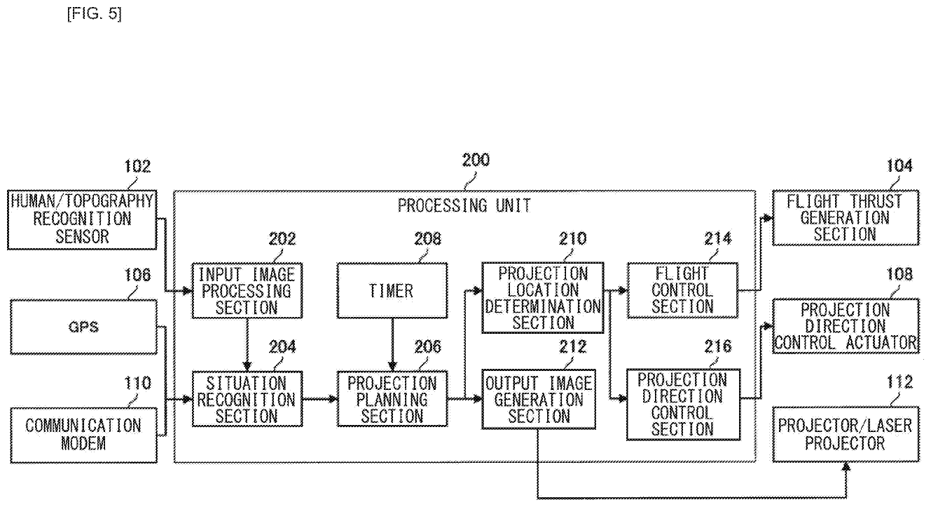

FIG. 3 is a flowchart illustrating an outline of a process for performing communication between the unmanned flying device 1000 and the person 20. Moreover, FIG. 4 is a schematic diagram illustrating a hardware configuration of the unmanned flying device 1000. Furthermore, FIG. 5 is a schematic diagram illustrating a software configuration of the unmanned flying device 1000.

As illustrated in FIG. 4, the unmanned flying device 1000 includes, as the hardware configuration, an input/output unit 100, a processing unit 120, and a battery 130. The input/output unit 100 includes a human/topography recognition sensor 102, a flight thrust generation section 104, a GPS 106, a projection direction control actuator 108, a communication modem 110, and a projector/laser projector (image presentation section) 112. Moreover, the processing unit 120 includes a processor 122, a memory 124, a GPU 126, and a storage 128. It is to be noted that, although the projector or the laser projector is exemplified as the image presentation section that presents an image on the ground from the unmanned flying device 1000, the image presentation section is not limited thereto.

The human/topography recognition sensor 102 includes a camera such as an infrared (IR) stereo camera, and captures an image of the ground. It is to be noted that, although the human/topography recognition sensor 102 is described below as including a camera, the human/topography recognition sensor 102 may include a ToF sensor, a LIDAR, or the like.

The flight thrust generation section 104 includes a propeller, a motor that drives the propeller, and the like. It is to be noted that the flight thrust generation section 104 may generate thrust by a configuration other than the propeller and the motor. The GPS 106 acquires positional information of the unmanned flying device 1000 using a global positioning system (Global Positioning System). The projection direction control actuator 108 controls a projection direction of the projector/laser projector 112. The communication modem 110 is a communication device that communicates with a communication apparatus held by the person 20.

Moreover, as illustrated in FIG. 5, the unmanned flying device 1000 includes a processing unit 200 as the software configuration. The processing unit 200 includes an input image processing section 202, a situation recognition section 204, a projection planning section 206, a timer 208, a projection location determination section (presentation location determination section) 210, an output image generation section 212, a flight control section 214, and a projection direction control section (presentation direction control section) 216. It is to be noted that components of the processing unit 200 illustrated in FIG. 5 may include the processor 122 of the processing unit 120 in the hardware configuration as well as software (program) for causing the processor 122 to function. Moreover, the program may be stored in the memory 124 or the storage 128 of the processing unit 120.

### 3. Specific Process Performed by Unmanned Flying Device

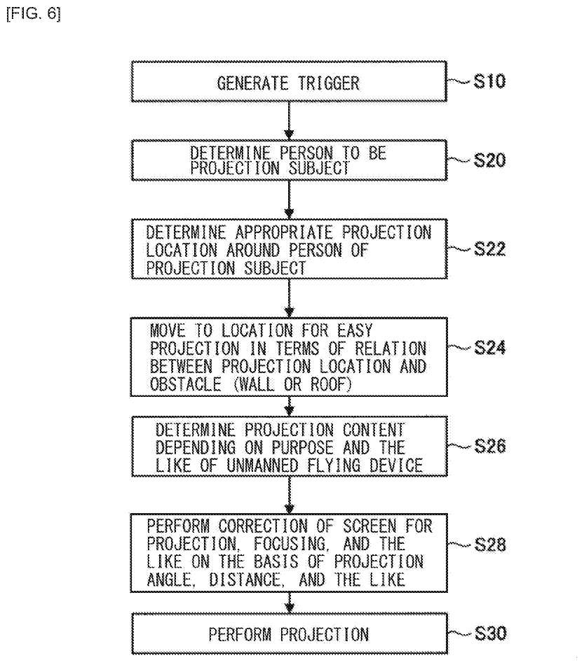

In the following, description is given of specific processes performed by the unmanned flying device 1000 on the basis of flowcharts in FIG. 3 and FIG. 6 and with reference to FIG. 4 and FIG. 5. As illustrated in FIG. 3, first, in step S10, some trigger is generated that causes an interaction between the unmanned flying device 1000 and the person 20 on the ground. Examples of an assumed trigger may include those described below. It is to be noted that the unmanned flying device 1000 is also able to constantly present information on the ground without the trigger.
Timing has arrived on a timer (specified time, regularly).
Random timing has arrived.
Has recognized a person on the ground.

It is to be noted that the recognition of a person includes recognition of a predetermined motion (gesture) of the person and recognition of a predetermined behavior of the person.
Has recognized a predetermined situation occurring on the ground.
A person on the ground has irradiated the unmanned flying device with light of a predetermined light emission pattern or wavelength.

The input image processing section 202 processes image information recognized by the human/topography recognition sensor 102, and the situation recognition section 204 recognizes results thereof, to thereby allow these triggers to be recognized by side of the unmanned flying device 1000. It is possible for the situation recognition section 204 to recognize various types of information such as a position of an object on the ground, a distance to the object on the ground, and the like on the basis of the result of image recognition. It is possible for the situation recognition section 204 to recognize whether or not a trigger is generated by comparing an image of a template corresponding to each of triggers stored in advance with the image information recognized by the human/topography recognition sensor 102, for example. More specifically, the situation recognition section 204 determines whether or not the recognition result matches a condition of each of the triggers stored in advance, and recognizes generation of a trigger in a case where there is a match therebetween. For example, it is possible for the situation recognition section 204 to determine whether or not there is a match in the trigger generation condition by complexly recognizing, using a detector, etc. that employs an existing technology such as image recognition, situations such as whether or not the person 20 or the object is within a range of specific coordinates (relative coordinates from the unmanned flying device 1000), and whether or not the person 20 is making a specific gesture.

In a case where the arrival of timing on the timer or the arrival of random timing is used as the trigger, it is possible to generate the trigger on the basis of time information obtained from the timer 208. It is to be noted that the above-described examples are not limitative; it is also possible to determine timing to generate the trigger depending on functions or purposes of the unmanned flying device 1000.

When a trigger is generated that causes projection in step S10, a process is executed in the next step S12 to project the circle FIG. 10 and the information 12 and 14 from the unmanned flying device 1000 on the ground surface. FIG. 6 is a flowchart illustrating a flow of the process.

First, on the basis of the trigger generated in step S10, a person on which information is to be projected is determined (step S20 in FIG. 6). For example, in a case where the person 20 making a predetermined gesture is the trigger, the person 20 is determined as a projection subject. Moreover, in a case where the trigger is caused by the timer or the like, a specific person 20 may sometimes not be targeted as the projection subject. In such a case, for example, it is possible to determine the projection subject in such a way as to performs projection directly below the unmanned flying device 1000, performs projection on the center position among a plurality of persons, performs projection on an empty space, or the like. Determination of the person 20 as the projection subject is made by the projection planning section 206 on the basis of the results recognized by the situation recognition section 204, or the like.

When the person to be the projection subject is determined, then a specific projection location is determined (step S22 in FIG. 6). A projection location determination section 210 determines the projection location depending on the position of the person 20 to be the projection subject determined in step S20 and on recognition results of the surrounding situation. It is possible for the situation recognition section 204 to recognize a sunny region and a shaded region of the ground surface, a structure (building, wall, roof, and the like) on the ground, and the like by recognizing the image information recognized by the human/topography recognition sensor 102. The circle FIG. 10 and the information 12 and 14 may sometimes not be easily visible from the person 20 on the ground when being projected on a bright ground surface. Therefore, the projection location determination section 210 determines a projection position to project the circle FIG. 10 and the information 12 and 14 on a dark location easier for the person 20 to see, on the basis of positions such as the sunny region and the shaded region of the ground surface, a structure on the ground, and the like recognized by the situation recognition section 204.

Moreover, the unmanned flying device 1000 determines where to project information on the basis of an orientation of the face of the person 20, an orientation of the line of sight, and the like. At that time, the situation recognition section 204 recognizes the orientation of the face of the person 20 and the orientation of the line of sight from results of image processing processed by the input image processing section 202. It is to be noted that a known method may be used appropriately for recognition of the orientation of the face and the orientation of the line of sight based on the image processing. The projection location determination section 210 determines a location at which the person 20 is looking as the projection location on the basis of the orientation of the face of the person 20, the orientation of the line of sight, and the like. Moreover, it is possible for the projection location determination section 210 to determine the center position among the plurality of persons 20, the empty space, and the like on the ground as the projection position, on the basis of the result of the recognition, made by the situation recognition section 204, of the plurality of persons, the structure such as the building, and the topography on the ground.

The projection location may be, for example, a wall, a ceiling, or the like, besides the ground surface. Moreover, as a determination logic for the projection location, it is also possible to use a method of simply scoring various determination elements or advanced determination logic that employs machine learning or the like.

As described above, determination of the projection location is determined by the projection location determination section 210 on the basis of the information recognized by the situation recognition section 204.

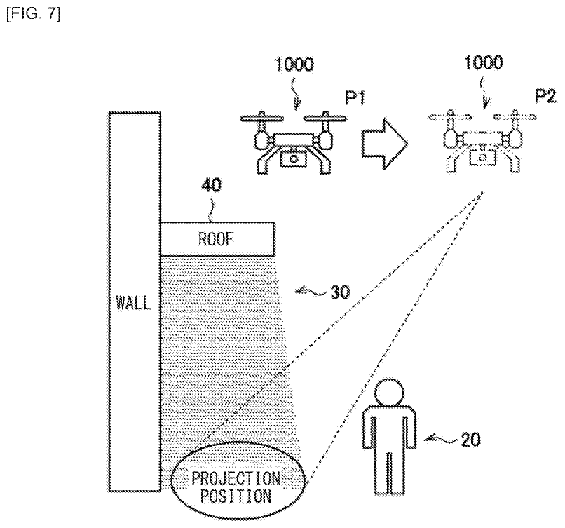

When the projection location is determined, the unmanned flying device 1000 moves to a location appropriate for projection on the location (step S24 in FIG. 6). FIG. 7 is a schematic diagram illustrating how the unmanned flying device 1000 moves. FIG. 7 illustrates a case of projection on a shade 30 near the person 20. In the case of this example, because of the presence of a roof 40, it is not possible for the unmanned flying device 1000 to perform projection on the shade 30 when being located at a position P1. Thus, it is necessary for the unmanned flying device 1000 to move to a position P2 (rightward from P1) appropriate for projection.

Meanwhile, in a case where the unmanned flying device 1000 is originally located at the position P2, it is possible for the unmanned flying device 1000 to perform projection on the shade 30 by controlling the projection position, projection angle, projection distance, or the like using the projector/laser projector 112 without moving.

When moving the unmanned flying device 1000, conditions (projection angle and projection distance) are taken into account, such as motions and constraints of the projection direction control actuator 108 that controls the projection direction and the projection angle of the projector/laser projector 112. It is possible to minimize the move of the unmanned flying device 1000 by controlling the projection angle, and the like.

The flight control section 214 controls the flight thrust generation section 104 to thereby move the unmanned flying device 1000. The flight control section 214 controls the flight thrust generation section 104 on the basis of the distance to the projection location and the position of the projection location and also on the basis of the positional information obtained from the GPS 106. Moreover, the projection direction control section 216 controls the projection direction control actuator 108 to thereby cause the projector/laser projector 112 to control the projection position, the projection angle, the projection distance, and the like. The projection direction control section 216 controls the projection direction control actuator 108 to cause the projector/laser projector 112 to present an image on the projection location.

Moreover, the projection planning section 206 determines a projection content along the function or the purpose of the unmanned flying device 1000 (step S26 in FIG. 6). In a case where the trigger for projection is an action (gesture such as raising the right hand) of the person 20, the content along the action is to be projected. As examples of information of the projection content, the followings are conceivable.

The information 12 for communicating with the person 20 on the basis of the action of the person 20.
“In a case of OO, please raise your right hand.”
“In a case of OO, please enter the circle below for X seconds or longer.”
“In a case of OO, please step on the shadow of the unmanned flying device.”

The information 14 for establishing communication with the communication apparatus (such as a smartphone) held by the person.
“Please read the following QR code (registered trademark) with OO application of your smartphone.”
“Please read the following character string/image with your smartphone.”

When the projection location and the projection content are determined, correction such as focusing or keystone correction is performed depending on the projection angle, the projection distance, and the like (step S28 in FIG. 6), and projection is started by the projector/laser projector 112 included in the unmanned flying device 1000 (step S30 in FIG. 6).

At this time, the output image generation section 212 generates images of the circle FIG. 10, the information 12 and 14, and the like to be projected on the basis of the projection content determined by the projection planning section 206, and sends the generated images to the projector/laser projector 112. This allows the projection content generated by the output image generation section 212 to be projected on the ground surface by the projector/laser projector 112. In this manner, the process in FIG. 6 is completed.

Thereafter, the process returns to FIG. 3. In step S14 in FIG. 3, the person 20 on the ground is to perform reaction on the basis of the projected information. As types of the reaction, the followings are conceivable. The reaction of the person 20 is recognized by the situation recognition section 204 on the basis of the image information recognized by the human/topography recognition sensor 102.
To move to a specific location.
To strike a specific pose.
To make a specific gesture.
To point at a certain location.
To read a QR code (registered trademark), an image, a character string, and the like using a communication apparatus such as a smartphone.

The reaction performed by the person 20 is recognized by the situation recognition section 204 on the basis of information recognized by the human/topography recognition sensor 102 of the unmanned flying device 1000. Moreover, in a case where the person on the ground reads the information 14 such as the QR code (registered trademark), the image, and the character string using the communication apparatus such as the smartphone, the reaction is acquired by the communication modem 110 and recognized by the situation recognition section 204. That is, the projector/laser projector 112 recognizes the position, the posture, or the movement of the person 20 or receives wireless communication to thereby perform recognition of the reaction. The situation recognition section 204 also functions as a reaction recognition section that recognizes the reaction.

A plurality of times of communication may be necessary in some cases between step S12 and step S14 depending on the content of the reaction. For example, a case where the unmanned flying device 1000 presents the information 12 about an option such as “Which is to be executed, A or B?” or the information 12 on a procedure of reconfirmation such as “Is it allowed to perform C?” holds true. In such a case, the process is to return again from step S14 to the projection process in step S12.

After step S14, the process proceeds to step S16. In step S16, the unmanned flying device 1000 is to take a specific action depending on the reaction from the person on the ground. As the content of the action, the followings are conceivable depending on the function or the purpose of the unmanned flying device 1000.
To descend to or land near the subject person 20.
To move to a specific location.
To start recording or filming with a camera.
To recognize a position or a posture of the subject person 20 by the human/topography recognition sensor 102.
To perform wireless communication with the person 20 on the ground.
To make emergency contact (such as an ambulance and a fire department).
To do nothing (return to the original autonomous flight. So-called cancellation).

In a case where the above-described action “To descend to or land near the subject person,” it is then possible for the unmanned flying device 1000 to move to, for example, the following actions.
To receive a package.
To buy and sell a commercial product.
To deliver a leaflet or the like for advertisement.

As described above, according to the present embodiment, it is possible to simply and promptly communicate between the autonomously operating unmanned flying device 1000 and the person 20 on the ground with no need for preliminary knowledge. This makes it possible to exchange an instruction, a request, and the like without relying on an owner or a manufacturer of the unmanned flying device 1000, for example, in a case where it is desired to promptly request something from the unmanned flying device 1000 flying over the head of the person 20 at a certain timing.

Although the description has been given above in detail of preferred embodiments of the present disclosure with reference to the accompanying drawings, the technical scope of the present disclosure is not limited to such examples. It is obvious that a person having ordinary skill in the art of the present disclosure may find various alterations or modifications within the scope of the technical idea described in the claims, and it should be understood that these alterations and modifications naturally come under the technical scope of the present disclosure.

In addition, the effects described herein are merely illustrative or exemplary, and are not limitative. That is, the technology according to the present disclosure may achieve, in addition to or in place of the above effects, other effects that are obvious to those skilled in the art from the description of the present specification.

It is to be noted that the technical scope of the present disclosure also includes the following configurations.

(1)

A flying vehicle including:

an image presentation section that presents an image for requesting an action from a person; and

a situation recognition section that recognizes a situation,

the image presentation section presenting the image on a basis of the situation recognized by the situation recognition section.

(2)

The flying vehicle according to (1), including a projection planning section that specifies a subject person to whom the image is presented on a basis of the situation recognized by the situation recognition section, in which

the image presentation section presents the image to the subject person.

(3)

The flying vehicle according to (2), in which the projection planning section determines the subject person on a basis of a gesture of the subject person.

(4)

The flying vehicle according to (2) or (3), in which the projection planning section defines a content of the image on a basis of the situation recognized by the situation recognition section.

(5)

The flying vehicle according to (4), in which the projection planning section determines a content of the image on a basis of a gesture of the subject person.

(6)

The flying vehicle according to any one of (3) to (5), in which the image presentation section presents the image using the gesture as a trigger.

(7)

The flying vehicle according to any one of (1) to (6), including a presentation location determination section that determines a location where the image is presented on a basis of the situation recognized by the situation recognition section, in which

the image presentation section presents the image to a location determined by the presentation location determination section.

(8)

The flying vehicle according to (7), in which the presentation location determination section determines a shaded region as a location where the image is presented on a basis of the situation recognized by the situation recognition section.

(9)

The flying vehicle according to any one of (1) to (8), including

a flight thrust generation section that generates thrust for flight, and

a flight control section that controls the flight thrust generation section on a basis of the situation recognized by the situation recognition section.

(10)

The flying vehicle according to any one of (1) to (9), including a presentation direction control section that controls a direction in which the image is presented by the image presentation section.

(11)

The flying vehicle according to any one of (1) to (10), in which the image generation section generates the image for requesting a predetermined motion from the person on a ground.

(12)

The flying vehicle according to any one of (1) to (11), in which the image generation section generates the image for establishing communication with the person on the ground.

(13)

The flying vehicle according to any one of (1) to (12), including a reaction recognition section that recognizes a reaction performed by the person on the ground depending on the image presented on the ground.

(15)

A method of controlling a flying vehicle, the method including:

presenting an image for requesting an action from a person; and

recognizing a situation,

the image being presented on a basis of the recognized situation.

### DESCRIPTION OF THE REFERENCE NUMERALS

1000 flying vehicle
104 flight thrust generation section
112 projector/laser projector
204 situation recognition section
206 projection planning section
210 projection location determination section
212 output image generation section
214 flight control section
216 projection direction control section

1. A flying vehicle comprising:
an image presentation section that presents an image for requesting an action from a person; and
a situation recognition section that recognizes a situation,
the image presentation section presenting the image on a basis of the situation recognized by the situation recognition section.

2. The flying vehicle according to claim 1, comprising a projection planning section that specifies a subject person to whom the image is presented on a basis of the situation recognized by the situation recognition section, wherein
the image presentation section presents the image to the subject person.

3. The flying vehicle according to claim 2, wherein the projection planning section determines the subject person on a basis of a gesture of the subject person.

4. The flying vehicle according to claim 2, wherein the projection planning section defines a content of the image on a basis of the situation recognized by the situation recognition section.

5. The flying vehicle according to claim 4, wherein the projection planning section determines a content of the image on a basis of a gesture of the subject person.

6. The flying vehicle according to claim 3, wherein the image presentation section presents the image using the gesture as a trigger.

7. The flying vehicle according to claim 1, comprising a presentation location determination section that determines a location where the image is presented on a basis of the situation recognized by the situation recognition section, wherein
the image presentation section presents the image to a location determined by the presentation location determination section.

8. The flying vehicle according to claim 7, wherein the presentation location determination section determines a shaded region as a location where the image is presented on a basis of the situation recognized by the situation recognition section.

9. The flying vehicle according to claim 1, comprising
a flight thrust generation section that generates thrust for flight, and
a flight control section that controls the flight thrust generation section on a basis of the situation recognized by the situation recognition section.

10. The flying vehicle according to claim 1, comprising a presentation direction control section that controls a direction in which the image is presented by the image presentation section.

11. The flying vehicle according to claim 1, comprising an image generation section that generates the image, wherein
the image generation section generates the image for requesting a predetermined motion from the person on a ground.

12. The flying vehicle according to claim 11, wherein the image generation section generates the image for establishing communication with the person on the ground.

13. The flying vehicle according to claim 1, comprising a reaction recognition section that recognizes a reaction performed by the person on a ground depending on the image presented on the ground.

14. A method of controlling a flying vehicle, the method comprising:
presenting an image for requesting an action from a person; and
recognizing a situation,
the image being presented on a basis of the recognized situation.
